(19) United States
(12) Patent Application Publication
(10) Pub. No.: US 2007/0219654 A1
(43) Pub. Date: Sep. 20, 2007

(54) Internet-based advertising via web camera search contests

(75) Inventors: Bentley Dean Frink, (US); George Henry Hutaff McEachern, (US)

Correspondence Address: Bentley Dean Frink, 5621 Harvest Grove Lane, Wilmington, NC, 28409, US

(73) Assignee: Viditotus LLC

(21) Appl. No.: 11/601,296

(22) Filed: Nov. 17, 2006

Related U.S. Application Data
(60) Provisional application No. 60/782,088, filed on Mar. 14, 2006.
(60) Provisional application No. 60/850,873, filed on Oct. 10, 2006.

(51) Int. Cl. G06F 19/00

(52) U.S. Cl. 700/91

(57) ABSTRACT

A contest system and method providing an interactive Internet-based contest including steps of providing at least one real-time image on at least one networked display, and verifying an answer to at least one question posed in reference to the image. The system and method in alternate embodiments provides a network controllable vehicle equipped with a network camera for providing at least one image on at least one networked display.

This application claims the benefit of the filing date of Provisional Application No. 60/782,088, filed Mar. 14, 2006. This application also claims the benefit of the filing date of Provisional Application No. 60/850,873, filed Oct. 10, 2006.

### BACKGROUND OF THE INVENTION

1) Field of the Invention

The present invention relates, generally, to online marketing and, more specifically, to a method and system for conducting a contest that displays contest sponsor advertisements on web pages having a contest interface.

2) Description of the Prior Art

The Internet and particularly the World Wide Web serves as a highly profitable medium for the advertisement and sale of goods and services. Most modern marketing efforts include Internet web sites that have advertising in the form of web page images and multi-media presentations. The effectiveness of such marketing efforts is dependent on potential customers being attracted to a web site often enough to identify goods and services with the web site's advertising content. Studies have shown that it takes many repeat visits to a web site for web-based advertising to be effective. Therefore a system and method is needed to repeatedly attract potential customers to a web site containing a marketing effort's advertising media.

### SUMMARY OF THE INVENTION

The above need is met by the present invention, which provides a contest method for attracting customers repeatedly to a contest web site containing sponsors' advertising media. The novel contest system and method provides an interactive Internet-based contest including steps of providing a real-time image on a networked display, and verifying an answer to at least one question posed in reference to the image. The real-time image can be generated by computer hardware/software or by a camera.

In particular, one embodiment of the present invention includes at least one camera in communication with the Internet, and is installed at a location that is not disclosed to the public. Preferably, the at least one camera is a Pan/Tilt/Zoom (PTZ) color camera housed in an outdoor enclosure having an optical plastic or glass window or dome. It is also preferred that the at least one camera is an Internet Protocol network camera having built-in server software that serves video and/or still images to a general purpose Internet web browser. The built-in server eliminates the need for a personal computer to capture and transfer images. A suitable Network camera is the VB-C50iR Canon Network Camera, which includes server functions for distributing live video through a network such as the Internet.

Preferably, the Network camera is enabled to capture a real-time video stream at a rate that is greater than or equal to 30 frames per second. It is also preferred that video compression is employed to lessen bandwidth requirements. A Motion-JPEG type video compression is generally acceptable. Moreover, it is beneficial for the Network camera to include viewer software that gives a user full remote control of the Network camera's pan angle, tilt angle and zoom magnification. A plurality of other users can concurrently view the video distribution. The VB-C50iR Canon Network Camera is capable of distributing video to fifty viewers concurrently. Moreover, a video rebroadcasting server can increase the number the concurrent video feeds by an order of magnitude. As a result, hundreds or thousands of other viewers could be provided with the opportunity to concurrently view a given video feed. Importantly, the video rebroadcasting server hides the camera's IP address so that IP packet tracing techniques cannot be used to locate the geographic region in which the contest camera is located.

The VB-C50iR Canon Network camera has a high-performance 26× zoom, and a pan angle range of at least 200 degrees. Generally, 100 degrees to the left of center and 100 degrees to the right of center. Its tilt angle range is at least 100 degrees, typically being 10 degrees in an upward direction and 90 degrees in a downward direction or vice versa, depending how the camera is mounted.

The preferred camera also includes an automatic focus feature. Another preferred feature is a shade correction function that adjusts the contrast of the video for when the background of a scene is bright, making a subject difficult to see. Another suitable contest camera would be Sony SNC-RZ30N/2 IP Network Pan/Tilt/Zoom Color Camera housed in an outdoor enclosure having an optical plastic or glass window or dome.

The contest camera is positioned to view in real-time an outdoor scene that includes scenery identifiable in publicly accessible satellite imagery of the earth. Preferably, the contest camera is an interactive pan/tilt/zoom (PTZ) camera that is positioned to give a contestant real-time views of an outdoor scene that includes portions of the sky. For example, the contest camera could be installed on an outdoor pole or tower. The contest camera could also be installed on a building or within a building such that the camera will give contestants an outdoor view. Preferably, the contest camera is in communication with an Internet web site that includes a user interface that allows a contestant to control the positioning of the contest camera for a predetermined amount of time. Moreover, the preferred interface will allow the contestant to download snapshots of scenery for review.

One version of the contest rules allows contestants to earn camera control time. For example, a contestant will be provided with questions, and for each correct answer they will be granted a predetermined amount of camera control time. The questions could be but are not limited to, general trivia questions, questions pertaining to the contest scene, and questions pertaining to advertisements including sponsor advertised products and/or services. The camera control earned time can be banked, and the contestant will be given an access code for gaining control of the camera at a future time. Moreover, the earned access time may be scheduled by the contestant or by an administrator or automatically generated by the website. The schedule and access code may be emailed to the contestant having earned the camera control time.

Alternately, the contestants are able to earn camera control time by clicking through sponsor advertisements and/or sponsor websites. For example, a contestant will be enticed to follow advertising links and/or play infomercial multimedia links in order to earn camera control time.

The contest sponsor's objective is to advertise products and/or services to potential customers by attracting the potential customers to one or more web sites that include sponsor advertisements. For example, a web page having the contest camera interface preferably includes one or more sponsor advertisements. Moreover, a video stream containing multimedia commercial advertising will be played intermittently within the contest camera video stream, and hints or tips pertaining to how to discover the location of the undisclosed camera will be presented on sponsor web pages hyper-linked from the contest website. Moreover, hints pertaining to how to discover the contest camera location could be provided by associating the hints with a contest sponsors and/or service.

Furthermore, sponsor advertisements will be placed within various fields of view of the camera. In addition, sponsor products will be placed within the contest camera's view. For example, an automobile manufacturer could place a product car in the contest scene to display the car for a limited duration. Trivia questions for the contestants would pertain to the product car. One such question would be to ask the contestants about the physical characteristics of a product car shown in the contest scene at a particular time. The questions could be as simple as: “What is the make, model and color of the product car shown in last hour's scene?”

The contestant's objective is to be the first contestant to correctly identify or pinpoint the undisclosed location of an interactive contest camera to within a predefined accuracy using camera views from the contest camera combined with data that the contestant gathers using an Internet search engine. Preferably, contestants will use a sponsor's hints or tips to discover the location of the undisclosed contest camera. Hints could include but are not limited to:

a) Observing sunrise, sunset, moon rise and moon set times at the contest camera location to discover the regional location of the contest camera. For example, sunrise and sunset times observed by the contestant can be compared with sunrise and sunset tables provided for various locations around the world. These tables could be located at a web site containing sponsor advertisements. The position of other astronomical bodies such as planets and stars could also be used to resolve the contest camera location. The planet Venus is at times clearly viewable with some web cameras.

b) Observing weather conditions at the contest camera location to further refine the approximate location of the contest camera. For example, a contestant might observe precipitation at the camera location and compare the observation with real-time regional radar images to further refine the location of the contest camera. Web sites containing sponsor advertisements could provide the real-time radar images. Some publicly available radar web pages include an interface function that allows the user to precisely locate precipitation storms by moving a graphical user interface cursor that reports longitude and latitude over a web-based radar image of the storm to be located. Similarly, contestants could monitor the sky over the contest camera to make cloud formation observations. The contestant could then compare the cloud formation observations with cloud formation images found in publicly available near real-time high-resolution satellite images to further refine the location of the contest camera. Similar to radar images, satellite images may also include a user interface function that allows the user to precisely locate cloud formations by moving a graphical user interface cursor that reports longitude and latitude over a web-based satellite image of the cloud formation to be located.

c) Searching publicly available high-resolution images of the earth's surface using the longitude and latitude data derived using hints a) and b) to select a high-resolution image suspected to contain scenery that matches observed contest camera scenery. For example, 0.25 m resolution images of the earth surface is publicly available in the GOOGLE Earth database that is longitude and latitude searchable. At the 0.25 m resolution these images offer, a contestant would be able to match scenery such as residential homes, driveways, swimming pools and landscaping such as hedges and small tree clusters.

Once a contestant believes he or she has correctly matched the scenery, thereby locating the contest camera, they can register their find with the contest's officials. Preferably, the web site will have a registration form in which the contestant can enter his or her contact information along with their answer of where they believe the contest camera is located. The answer could take any number of forms, such as longitude and latitude, street address, postal code (i.e., zip code) or a copy of matching scenery and GOOGLE Earth imagery. The contest could reward any number of contestants giving a correct answer or the contest could reward only the first contestant to give the correct location. In the case of an answer given in the form of a street address, postal code or a longitude-latitude fix, the web site could be programmed to automatically immediately notify the winning contestant of the results.

The contest could offer tiers of complexity and prizes. For example, the lowest value prize or reward could be given to the first contestant to identify the region of the earth where the contest camera is located. The next level prize or reward could be given to the first contestant to identify the state or province where the contest camera is located. The next level prize could be awarded to the contestant that correctly identifies the city or county that the contest camera is located in and so forth. The grand prize would be awarded to the contestant that precisely locates the contest camera to within a predefined resolution. For example, the predefined resolution could be to locate the contest camera to within 10 meters. A contest could be expected to last several weeks to several months depending upon the number of contestants and the availability of unique observations due to weather conditions and the like.

In accordance with the present invention, any given contest website will include a plurality of contests, each of which having at least one interactive camera. Therefore, a large network audience will be distributed among the plurality of contests. Thereby, providing any given contestant a relatively short wait in the contest camera queue. However, if any particular contest becomes so popular that a camera control queue wait would become unreasonably lengthy or impractical, the contest camera control is programmable to automatically go into a panoramic mode. The panoramic mode provides an automatic sequence of camera movements in at least one plane. In this way, the contestants will not become frustrated for control of the camera.

Alternately, a non-panning camera system having a very wide angle lens such as a fisheye type lens is provided and oriented with a scene such that a panoramic view of the contest scene is generated without the need for a camera panning means. Instead of needing stepper motors for pan and tilt functions, the non-panning camera captures an entire 360 degree panoramic scene instantly. A non-panning camera system that is suitable for use by the present invention is described in U.S. Pat. No. 7,071,968 to Novak, and is incorporated herein in its entirety.

In operation, a user of the present inventive system visits the web site interface using his or her personal computer web browser. Once at the web site interface, the user fills out the required personal contact, shipping address and payment information forms, or if the user is already registered with the web site they will enter their previously assigned user name and password. Next, the user can choose to earn remote control camera access time by visiting sponsor advertisements while waiting in a queue for control of the remote contest camera. A user will gain a predefined amount of time for each advertisement visited. Alternately, a user can earn camera control time by competing in a trivia and/or network base video game competition. In addition, a sponsors' retail products can include clues that are useable to earn camera time.

The user is notified when his or her remote control access period is available. After being granted access, the user can operate the remote Network camera via the camera pan, tilt and zoom scroll bars on the web page.

In yet another embodiment, the present invention provides a seek and find type contest. In this embodiment, contestants are asked to capture photographs of various features of interest within a real-time contest scene. The contestants will use a contest camera located at the contest site to capture the required photographs. The preferred camera for this seek and find contest is a Pan/Tilt/Zoom (PTZ) color camera housed in an outdoor enclosure having an optical plastic or glass window or dome. A suitable camera for this embodiment is the VB-C50iR Canon Network Camera described above.

An exemplary seek and find type contest of the present invention requires capturing photographs of flora and/or fauna listed in the contest's rules. A specific contest example would be to place a networked contest camera at a flora and fauna rich site such as can be found in the Florida Everglades. In this case, the flora and fauna list would include but not be limited to animals such as alligators, panthers and pelicans along with plants such as saw palmetto, moonvine and morning glory. The goal of the contest is to be the first to capture photographs of all of the animals on the list. Alternately, a goal will be to capture a photograph of any one of a rare animal or plant listed on a separate list. Preferably, the contest camera system will provide an authentication tag for each photograph captured using the contest camera. Any photographs entered without an authentication tag will be disqualified. It is preferred for the authentication tags to include a time and date stamp designating when a particular photograph was taken. The contest could be further extended to have contestants locate a photograph of corporate vehicles such as UPS or Fedex delivery trucks in an advertising effort to promote a sponsor such as Fedex or UPS. A prize could be given for the greatest number of vehicles photographed. The seek and find contest could be conducted with a plurality of cameras located in different geographical locations. For a greater challenge, the contestant could then click on the different camera sites in a certain sequence and search for the specific animals, plants or objects within the network displays that are listed on the webpage contest form. Sponsor sites could have logos or other sponsor identifiable trademarks hidden within the network display that would also be required to be found for the success of the contest. In addition to achieve a more challenging and educational contest the contestant upon finding the animals or flora and fauna, would have to answer a question or questions about the animal or flora/fauna correctly along with snapping a photo of the required animal or flora/fauna.

In still yet another embodiment, the present invention provides at least one interactive camera at a sports event. In this embodiment, contestants are presented with sports trivia questions. The contestants attempt to answer the questions to earn camera control time during the sports event. For example the interactive camera system of the present invention can be installed in a baseball dugout, so that the contestants can have total control of a unique up close and personal view of a game. The contestants will be awarded a predetermined amount of camera control time for each correct trivia question response. Greater amounts of camera control time can be given for correct answers to more difficult baseball trivia questions. Moreover, similar to the previous described embodiments, the contestants could also earn camera control time by viewing sponsor advertisements. Contestants can also be asked to locate various features of interest and answer questions posed in reference to the images streaming from the camera. The preferred camera for this sports event contest is a Pan/Tilt/Zoom (PTZ) color camera housed in an outdoor enclosure having an optical plastic or glass window or dome. A suitable camera for this embodiment is the VB-C50iR Canon Network Camera described above. In addition to earning camera control time, contestants could win prizes of various value by answering the questions posed during the game while watching the sports cam. Questions would include trivia about the players, the arena or the sponsors that are shown within or surrounding the network display. It could be possible to take part in a live auction during the games of team memorablia or autographs of one's favorite player. The camera controls of the sports cam could be set to preprogrammed stopping points to limit how much control a contestant would have. The sports cam could be placed at any number of sporting events including collegiate or professional basketball, baseball, hockey, soccer, football and others deemed to be suitable for the camera.

Still another embodiment of the present invention provides an Internet-based telepresence system and method that allows a user located anywhere that there is a computer with an Internet browser and Internet connection to search for, find, gather and receive natural and/or man-made objects. For example, the man-made objects include but are not limited to tokens, precious metal coins, jewelry, and various gift packages.

The system includes a remote control vehicle having at least one camera, at least one collecting arm and/or scoop and a collection bin. The system further includes a remote Internet connection at the telepresence site and a local Internet connection at the user's location. Preferably, the at least one camera is a Pan/Tilt/Zoom (PTZ) color camera housed in an outdoor enclosure having an optical plastic or glass window or dome. It is also preferred that the at least one camera is an Internet Protocol network camera having built-in server software that serves video and/or still images to a general purpose Internet web browser. The built-in server eliminates the need for a personal computer to capture and transfer images. A suitable Network camera is the VB-C50iR Canon Network Camera, which includes server functions for distributing live video through a network such as the Internet.

Preferably, the Network camera is enabled to capture video at a rate that is greater than or equal to 30 frames per second. It is also preferred that video compression is employed to lessen bandwidth requirements. A Motion-JPEG type video compression is generally acceptable. Moreover, it is beneficial for the Network camera to include viewer software that gives a user full remote control of the Network camera's pan angle, tilt angle and zoom magnification. A plurality of other users can concurrently view the video distribution. The VB-C50iR Canon Network Camera is capable of distributing video to fifty viewers concurrently. Moreover, a video rebroadcasting server can increase the number the concurrent video feeds by an order of magnitude. As a result, hundreds or thousands of other viewers could be provided with the opportunity to concurrently view a given video feed.

The VB-C50iR Canon Network camera has a high-performance 26× zoom, and a pan angle range of at least 200 degrees. Generally, 100 degrees to the left of center and 100 degrees to the right of center. Its tilt angle range is at least 100 degrees, typically being 10 degrees in an upward direction and 90 degrees in a downward direction or vice versa, depending how the camera is mounted.

The preferred camera also includes an automatic focus feature. Another preferred feature is a shade correction function that adjusts the contrast of the video for when the background of a scene is bright, making a subject difficult to see.

In the preferred embodiment, the remote control vehicle has a frame that includes a camera mast. The Network camera is housed inside a protective camera dome that is attachable to the mast. A first wireless transceiver and antenna for transmitting video and receiving camera control commands and remote control vehicle commands also uses the camera mast at a preferred mounting location. A second wireless transceiver located within wireless communication range of the first wireless transceiver is connected to the Internet by way of an Internet Service Provider. Suitable first and second wireless transceivers are included in a 900 Mhz Ethernet bridge such as the AvaLAN AW900x wireless Ethernet bridge. A global positioning system (GPS) receiver is also attachable to the camera mast.

A master vehicle controller secured to the remote vehicle frame is in communication with the first wireless transceiver and GPS receiver. The master vehicle controller includes at least one digital processor with firmware, software, random access memory and persistent digital memory. The master vehicle controller processes collection arm and vehicle control commands received by the first wireless transceiver. A primary function of the master vehicle controller is to compare spatial data received by the GPS receiver with a digital map stored in the master controller's random access and/or persistent memory. The digital map includes boundaries for preventing the remote controlled vehicle from traveling outside a predetermined area regardless of the remote control vehicle commands received. The master controller monitors the position of the vehicle and issues a stop command for the vehicle if the vehicle approaches a boundary. Preferably, the master vehicle controller sends messages to the user indicating the global or relative location of the remote vehicle. An alert can be sent to the user as the vehicle approaches a boundary.

The remote vehicle can be a land-craft, an aircraft, amphibious vehicle and/or a submersible vehicle. In the case of a land-based vehicle, wheels or tracks can be added to the frame for propulsion. An electric motor, internal combustion engine or an engine/electric motor hybrid power system can be used to power the wheels or tracks. In the case of an amphibious or submersible vehicle a fluid propeller can be driven by the power system. The power system is preferably a battery pack or electrical fuel cell having power conditioning and motor drive circuitry for the wheels or tracks and collector arm. Separate batteries can be used to power the master vehicle controller, Network camera, GPS and first transceiver.

The collector arm is robotic having a base and an end effector such as a gripper or scoop. In its simplest embodiment, the collector arm is a spherical type robot arm that can move approximately 210° at its base, and its arm has up-and-down and in-and-out movements (extension and retraction). These movements allow the robot to easily reach every point in its work envelope. In a more complex embodiment, the collection arm is a fully articulated six axis robot arm having a turning axis, lower arm, upper arm, wrist pitch axis and a wrist twist axis. In either embodiment, the arm base is mounted to the remote control vehicle frame. Other robot types such as cylindrical robots and rectilinear robots could be employed in combination with or instead of the above arm types.

A collection box for holding the users' collection of gathered objects is attachable to the vehicle frame at a location that is within the collection arm's work envelope. The collection box can include individual storage cells that are individually assignable to users. For example, predetermined movements of the collection arm can be programmed to automatically place a user's gathered objects into the user's assigned storage cell within the collection box. In this way, gathered objects collected by different users will be automatically separated.

An Internet server including a web site interface is provided for the user to control the remote control vehicle, collection arm and PTZ functions of the Network camera. In its basic form, the Internet server web site presents a web page to users via the Internet. The web page includes an image display area along with a pan camera scroll bar, a tilt camera scroll bar, and a zoom scroll bar for displaying real-time imagery from the remote control vehicle camera and interactively controlling the functions of the remote control vehicle camera. A user data entry form is also included on the web page for allowing a user to enter his or her contact information including a shipping address for the user's collected objects. A form is also included for entering the user's payment information, such as credit card or payment account information. The web page also includes spaces for revenue generating advertisements. Moreover, a video server between the remote control vehicle's camera and the web site interface can insert revenue generating video advertisements inside the image display area before a user takes control of the remote control vehicle and Network camera. Other areas of the web page are dedicated to scroll bars, radio buttons and other graphical user interface elements for controlling the travel direction and speed of the remote control vehicle as well as the motion of the collection arm.

In operation, a user of the present inventive system visits the web site interface using his or her personal computer web browser. Once at the web site interface, the user fills out the required personal contact, shipping address and payment information forms, or if the user is already registered with the web site they will enter their previously assigned user name and password. Next, the user can choose to earn remote control vehicle access time by visiting sponsor advertisements while waiting in a queue for control of the remote control vehicle. A user will gain a predefined amount of time for each advertisement visited. Alternately, a user can earn vehicle and camera control time by competing in a trivia and/or network base video game competition. In addition, sponsors' product will include clues that are useable to earn camera and vehicle control time.

The user is notified when his or her remote control access period is available. After being granted access, the user can operate the remote Network camera via the camera pan, tilt and zoom scroll bars on the web page. Once the user sees an object of interest in the video images from the camera, the user can command the vehicle to drive towards the object. At some point, the object will be within the work area of the collection arm. At this point, the user will command the vehicle to stop. Next, the user will use the web site web page interface to maneuver the collection arm end effector within gripping or scooping range of the end effector. The user then commands the collection arm to pick up the object of interest. The user can then command the collection arm to automatically place the gathered object into the collection box storage cell assigned to the current user. Until the user's purchased and/or earned time runs out, the user can continue to search for, find, and gather objects of interest using the present system.

At a regular interval, a worker at the remote site unloads the collected objects of each collection box storage cell into a shipping package addressed to the appropriate user. The users' shipping addresses are taken from a database linked to the shipping address form of the web site interface. The addressed packages are then shipped to the address provided by the user using a parcel carrier selected by the user. Suitable parcel carriers include but are not limited to, Federal Express® and United Parcel Service®.

The present method includes a step of providing the remote control vehicle of the present invention at a remote site having objects of interest for collectors. An exemplary, remote site would be a beach strand known to contain a variety of sought after seashells. Other exemplary sites include, but are not limited fossil beds containing sharks teeth, sections of Florida's gold coast where gold coins are found, and geological sites where precious and semi-precious gems can be found. Another step is to provide a wireless broadband Internet access point at the remote location for transmitting commands to the remote control vehicle and video from the remote vehicle's camera over the Internet. Yet another step provides an Internet server with a web site interface according to the system of the present invention. Another step provides a shipping service to deliver the collected objects of interest to the appropriate users.

A specific contest or game example is a treasure hunt type contest, wherein one or more of the above network controllable vehicles are available at a contest site having a loose soil field containing hidden or buried treasure such as gold coins or tokens that can be redeemed for prizes. The contestants' goal is to find and collect the treasure. Various adaptations of the contest or game, wherein contestants compete in head-to-head competition for collecting the treasure. For example, the vehicles could be equipped with wireless energy devices. Such wireless energy devices include but are not limited to eye safe laser transmitters receivers, ultrasonic transceivers and microwave transceivers. The wireless devices are used to direct energy onto targets that have receivers that in communication with the vehicles, such that the treasure is dropped and/or the vehicle is temporarily disabled. Contestants earn a predetermined amount of vehicle control time by correctly answering contests question.

The above disclosed vehicle is also useable in a contest, wherein a winning contestant is required to pinpoint the vehicle to within a predetermined accuracy. Global position feedback from the vehicles GPS to the contestant would be disabled. However, relative position feedback from predetermined boundaries would continue.

In still another embodiment, the interactive Internet-based contest comprises steps of:

a. providing a plurality of network cameras, each of which generating an image for a plurality of networked displays; and

b. verifying a contestant's answer to at least one question posed in reference to each image. For example, in this embodiment, the contestants must correctly answer at least one question in reference to an image generated by one of the plurality of network cameras before the contestants are presented with an image generated by another of the plurality of network cameras. The first contestant to successfully answer all questions in reference to all of the images generated by the plurality of network cameras is declared to have won the contest. Preferably, each image generated by the plurality of cameras is a real-time image. Preferably, the contest goal requires contestants to locate at least one scenery item from a list provided for the contest. It is also preferred that the correct answer is in the form of at least one digital image captured from the images generated by the plurality of cameras.

Other aspects of the present invention will become apparent to one skilled in the art upon a reading of the following detailed description of the invention, taken with the drawings.

### BRIEF DESCRIPTION OF THE DRAWINGS

FIG. 1 is a flow chart of the method steps of the preferred embodiment of the station version of the present invention.

FIG. 2 is a diagram illustrating the system level of the station version of the present invention.

FIG. 3 is a system diagram of the preferred embodiment of the mobile version of the present invention.

FIG. 4 is a flow chart of the method steps of the preferred embodiment of the mobile version of the present invention.

### DETAILED DESCRIPTION OF THE PRESENT INVENTION

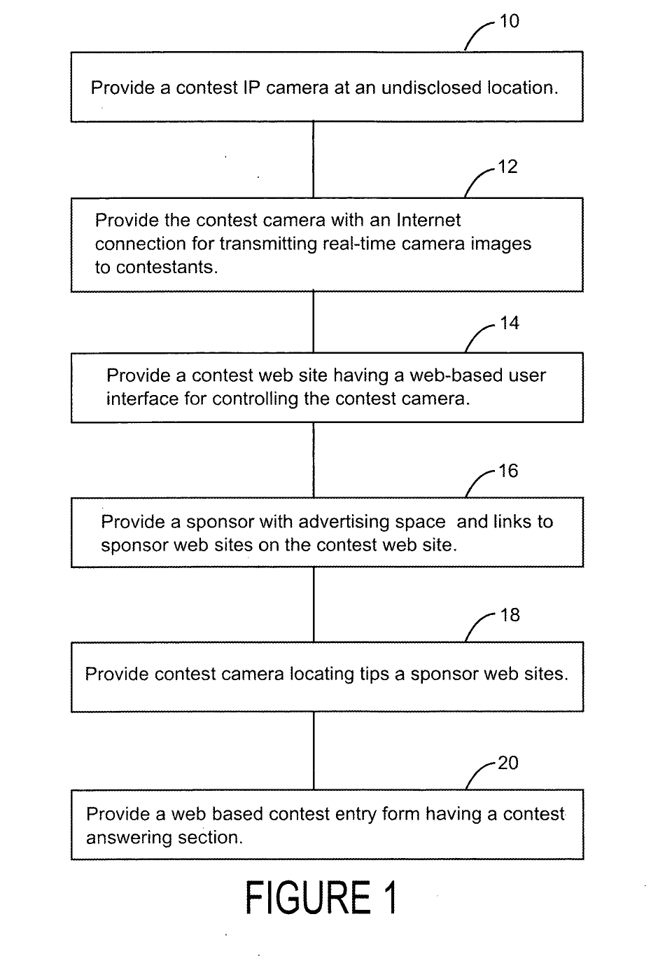

As generally shown in FIG. 1, the method comprises a step 10 of providing a contest camera at a publicly undisclosed location and a step 12 of providing a broadband Internet connection to the camera for displaying real-time images to contestants. Another step 14 provides a contest web site having a web-based user interface for viewing contest camera imagery and for controlling the pan/tilt/zoom functions of the contest camera. Yet another step 16 provides contest sponsor advertising web space combined with tips on how to use Internet resources and contest camera scenery observations to locate the camera through a process of elimination. Step 18 provides contest camera locating tips at sponsor web sites. Still another step 20 provides a web based contest entry form with a contest answer section.

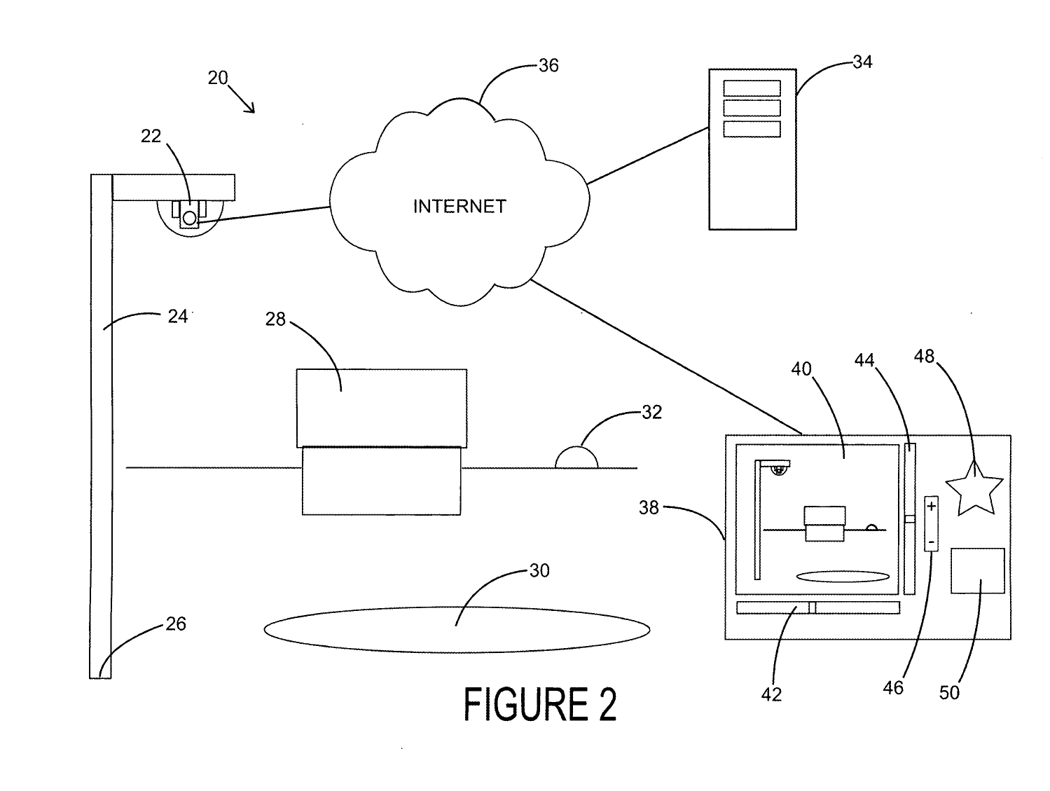

FIG. 2 depicts an overall system view 20 used with the method steps of the present invention. A dome housed pan/tilt/zoom contest camera 22 is mounted on a pole 24 installed at an undisclosed location 26. Scenery such as a building 28 is at least partially viewable by camera 22 and is identifiable on publicly available high-resolution satellite imagery. Other scenes such as a pond, lake or swimming pool 30 are readily identifiable in publicly available high-resolution aerial photography or satellite imagery. Camera 22 is preferably located such that a contestant can pan to view a sunrise or sunset 32.

Camera 22 is an Internet Protocol (IP) camera that communicates with at least one server 34 over the Internet 36. Camera 22's communication medium may be wired via fiber optic cables and/or electrically conductive cables or via a wireless link provided by wireless Internet providers like Verison and AT&T Cingular.

Server 34 also presents a contest web page 38 to contestants via the Internet 36. Web page 38 includes a contest image display area 40 along with a pan camera scroll bar 42, a tilt camera scroll bar 44, and a zoom scroll bar 46 for displaying real-time imagery from the contest camera and interactively controlling the functions of the contest camera. An advertisement 48 includes at least one tip pertaining to how to use Internet databases and contest camera observations to locate contest camera 22 is also displayed on web page 38. A contest data entry form 50 is also included on web page 38 for allowing a contestant to enter his or her contest camera location answer and personal contact information.

Certain modifications and improvements will occur to those skilled in the art upon a reading of the foregoing description. Such modifications and improvements have been deleted herein for the sake of conciseness and readability but are properly within the scope of the invention. For example, other tips for locating the contest camera would be for the contestant to use imagery from the contest camera to take note of soil colors and to identify vegetation in an effort to recognize the region on earth where the camera is located.

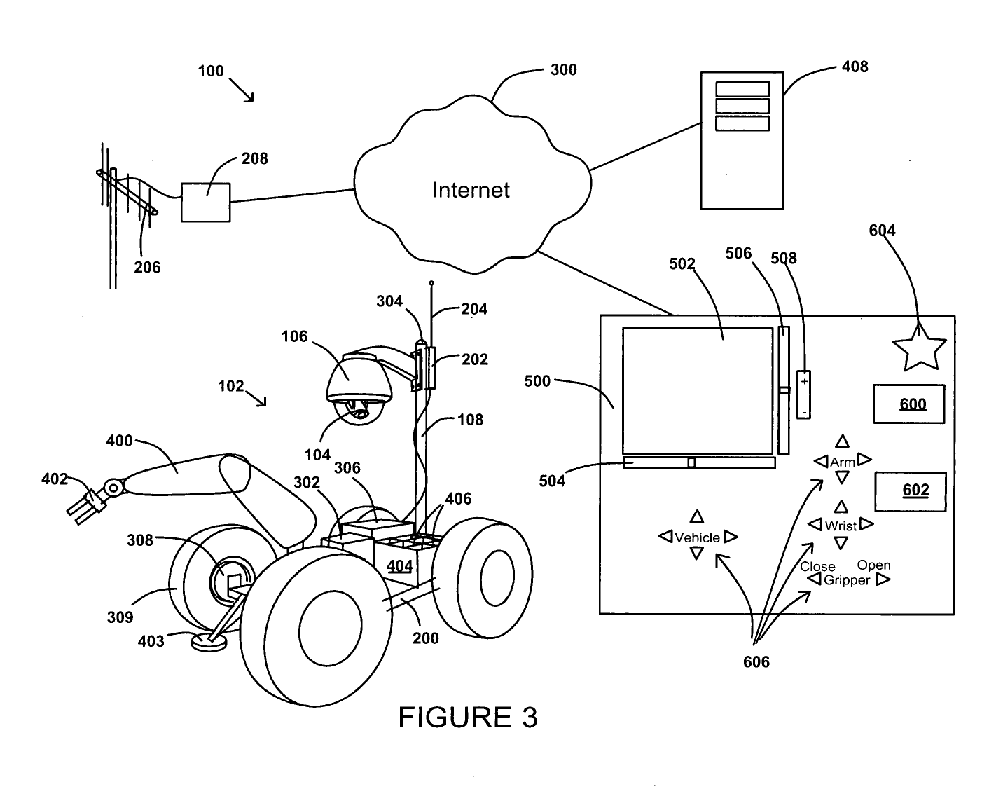

FIG. 3 depicts an overall system view 100 of the vehicle and camera control system that is useable with the method steps of the present invention. A remote control vehicle 102 includes a network camera 104 that is housed in a camera dome 106 attached to a camera mast 108, which in turn is attached to a vehicle frame 200. A first wireless transceiver 202 and first antenna 204 for transmitting video and receiving camera control commands and vehicle control commands is also attachable to mast 108. A second antenna 206 and second wireless transceiver 208 is located within wireless communication range of first wireless transceiver 202 and is connected to the Internet 300 by way of an Internet Service Provider.

A master vehicle controller 302 is attachable to vehicle frame 200 and is in communication with first transceiver 202. A GPS receiver 304 attachable to mast 108 is also in communication with controller 302.

A power system 306 is attachable to vehicle frame 200 and is a battery pack with power conditioning and motor driving circuitry for energizing at least one motor 308 to urge vehicle 102 in a user defined direction. At least one motor 308 can be a direct drive type that is directing attached to a vehicle wheel 309. A collection arm 400 having a gripper 402 that is useable for picking up objects of interest is attachable to frame 200. A collection box 404 having an array of individually addressable storage cells 406 is also attachable to frame 200 and is locatable within the work area of collection arm 40.

A metal detector 403 is attachable to frame 200 and is useable to locate metal objects of interest. Metal detector 403 is in communication with master vehicle controller 302. Readings from the metal detector are passed to Internet 300 by way of first and second transceivers 202 and 208.

An Internet server 408 including a web site interface is provided for the user to control remote control vehicle 102, collection arm 400 and PTZ functions of the Network camera 104. In its basic form, the Internet server web site presents a web page 500 to users via the Internet 300. Web page 500 includes an image display area 502 along with a pan camera scroll bar 504, a tilt camera scroll bar 506, and a zoom scroll bar 508 for displaying real-time imagery from remote control vehicle camera 104 and interactively controlling the functions of remote control vehicle camera 104. A user data entry form 600 is also included on the web page for allowing a user to enter his or her contact information including a shipping address for the users collected objects. A payment form 602 is included for entering the user's payment information, such as credit card or payment account information. The web page also includes spaces for revenue generating advertisements such as a banner ad 604. Other areas of the web page 500 are dedicated to graphical user interface elements 606 for controlling the travel direction and speed of remote control vehicle 102 as well as the motion of the collection arm 400.

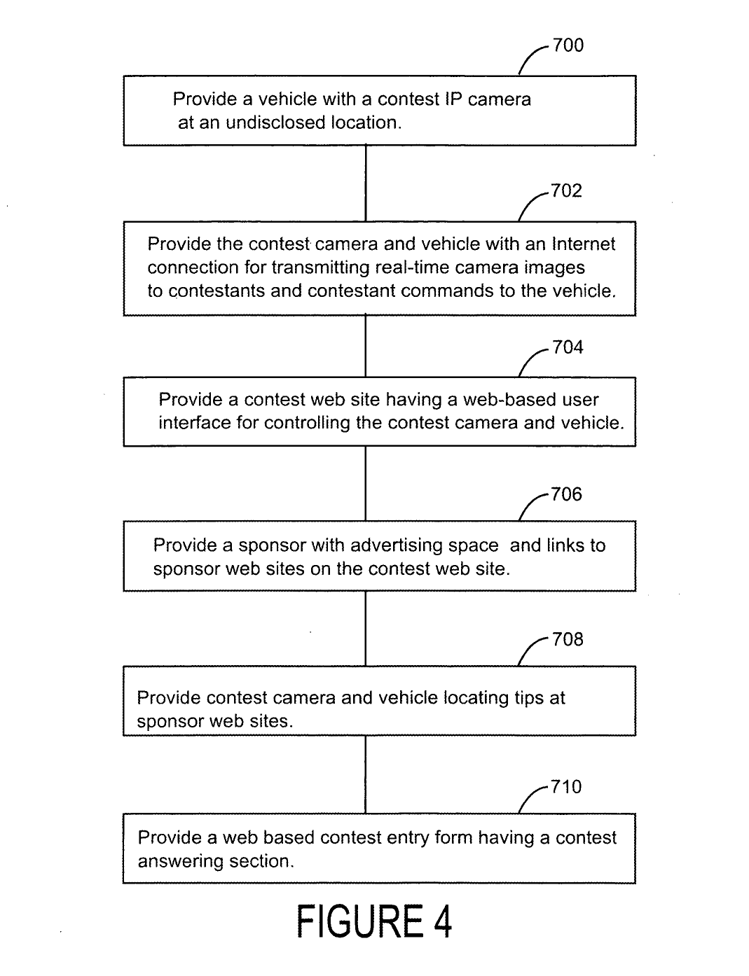

FIG. 4 depicts the method steps of the preferred embodiment of the invention. The telerobotic vehicle referred to in FIG. 4 is vehicle 102 of FIG. 3. As generally shown in FIG. 4, the method comprises a step 700 of providing a vehicle including a contest camera at a publicly undisclosed location, and a step 702 of providing a broadband Internet connection to the camera for displaying real-time images to contestants and for transmitting contestant commands for controlling vehicle 102 of FIG. 3. Another step 704 provides a contest web site having a web-based user interface for viewing contest camera imagery and for controlling the pan/tilt/zoom functions of the contest camera and the direction and speed of the vehicle. Yet another step 706 provides contest sponsor advertising web space combined with tips on how to use Internet resources and contest camera scenery observations to locate the vehicle through a process of elimination. Step 708 provides contest camera and vehicle locating tips at sponsor web sites. Still another step 710 provides a web based contest entry form with a contest answer section.

Certain modifications and improvements will occur to those skilled in the art upon a reading of the foregoing description. For example, the vehicle frame could be a stationary platform rather than have wheels or tracks for mobility. An example, of a stationary platform embodiment would be an Internet-based gold panning system wherein the users would control a collection arm equipped with a gold panning end effector that gathers gold from a stream exiting a gold mine, etc. The gold particles or nuggets would be automatically placed in collection box storage cells assigned to individual users.

In other embodiments, the collection arm can include attachable and detachable end effectors such as magnets, hammers and chisels, etc. Moreover, the manipulator arm could be replaced with a vacuum device that transfers objects of interest into a collection bin. Preferably, the video streams will accompanied by audio streams captured by sound transducers locatable at the contests sites. The sound transducers include but are not limited to microphones. It should be understood that all such modifications and improvements have been deleted herein for the sake of conciseness and readability but are properly within the scope of the following claims.

What is claimed is:

1. An interactive Internet-based contest comprising steps of:
a. providing at least one real-time image on a networked display; and
b. verifying an answer to a question posed in reference to said at least one real-time image.

2. The contest of claim 1, wherein said at least one image is generated by a camera.

3. The contest of claim 2, wherein said camera is remotely controllable over the Internet.

4. The contest of claim 3, including a means for allowing a contestant to move the aim of said camera through at least one plane.

5. The contest of claim 2, including a means for automatically moving the aim of said camera through at least one plane.

6. The contest of claim 1, wherein said at least one real-time image is a video stream.

7. The contest of claim 3, wherein said question asks contestants to provide an answer that pinpoints the location of said camera.

8. The contest of claim 7, wherein said answer is the postal code of the geographic region of where said camera is located.

9. The contest of claim 7, wherein said answer is the longitude and latitude of where said camera is located.

10. An interactive Internet based contest comprising steps of:
a. providing a real-time camera generated image on a networked display; and
b. verifying an answer to a question posed in reference to said image.

11. The contest of claim 10, wherein said question asks contestants to provide an answer that pinpoints said camera's location.

12. The contest of claim 11, wherein said answer is the postal code of the geographic region of said camera's location.

13. The contest of claim 11, wherein said answer is the longitude and latitude of said camera's location.

14. The contest of claim 11, further including a step of providing contest sponsor advertising that includes hints of how contestants can locate said camera.

15. The contest of claim 11, further including a step of providing a hint of how to locate said camera, wherein said hint is associated with sponsor advertisements.

16. The contest of claim 10, wherein said question asks contestants to locate at least one scenery item from a list provided for the contest.

17. The contest of claim 16, wherein said answer is in the form of a digital image captured from the image generated by said camera.

18. The contest of claim 10, wherein said camera provides scenery of a live sporting event.

19. The contest of claim 18, wherein said question asks contestants to provide an answer about the sporting event scenery.

20. An interactive Internet-based contest comprising steps of:
a. providing a network controllable vehicle equipped with a network camera for providing at least one image on a networked display; and
b. verifying an answer to a question posed in reference to said at least one image.

21. The contest of claim 20, wherein said question asks contestants to provide an answer that pinpoints said vehicle's location within a predetermined accuracy.

22. The contest of claim 21, wherein said answer is the postal code of the geographic region of said vehicle's location.

23. The contest of claim 21, wherein said answer is the longitude and latitude of said vehicle's location.

24. The contest of claim 20, wherein contestants earn a predetermined amount of vehicle control time by correctly answering said question.

25. An interactive Internet-based contest comprising steps of:
a. providing a plurality of network cameras, each of which generating an image for a plurality of networked displays; and
b. verifying a contestant's answer to at least one question posed in reference to each image.

26. The interactive Internet-based contest of claim 25, wherein answering said at least one question in reference to an image generated by one of said plurality of network cameras presents the contestant with an image generated by another of said plurality of network cameras.

27. The interactive Internet-based contest of claim 26, wherein the first contestant to successfully answer all questions in reference to all of the images generated by said plurality of network cameras is declared to have won said contest.

28. The interactive Internet-based contest of claim 26, wherein each image is a real-time image.

29. The contest of claim 25, wherein said question asks contestants to locate at least one scenery item from a list provided for the contest.

30. The contest of claim 29, wherein said answer is in the form of digital images captured from the images generated by said plurality of cameras.

31. A system for providing an Internet-based contest, said system comprising:
a. at least one network camera for streaming real-time images to networked displays for contestants to view;
b. a network server in communication with said at least one network camera;
c. a contest web page that presents contestants with at least one question pertaining to the real-time images streamed by said at least one network camera; and
d. a server software component for verifying the correctness of contestant answers pertaining to said at least one question.

32. The system of claim 31, further including a means for allowing a contestant to move the aim of said at least one network camera through at least one plane.

33. The system of claim 32, further including a web page having a graphical user interface in communication with said at least one network camera for controlling the camera's functions.
